(19) United States
(12) Patent Application Publication
(10) Pub. No.: US 2024/0318007 A1
(43) Pub. Date: Sep. 26, 2024

(54) RADIATION CURABLE COMPOSITIONS FOR ADDITIVE MANUFACTURING OF TOUGH OBJECTS

(71) Applicant: EVONIK OPERATIONS GMBH, Essen (DE)

(72) Inventors: Yili WU, Singapore (SG); Erwin PENG, Singapore (SG); Soumya SARKAR, Singapore (SG); Dinesh Kumar BASKER, Singapore (SG); Peter ALTENBUCHNER, Münster (DE); Ma Monica Carlos DELA CRUZ, Singapore (SG)

(73) Assignee: EVONIK OPERATIONS GMBH, Essen (DE)

(21) Appl. No.: 18/272,582

(22) PCT Filed: Jan. 17, 2022
(86) PCT No.: PCT/EP2022/050868

§ 371 Date: Jul. 16, 2023

(30) Foreign Application Priority Data
Jan. 19, 2021 (EP) 21152208.1

(51) Int. Cl. C09D 4/00; B29C 64/112; B29C 64/30; B29K 67/00; B29K 75/00; B29K 105/00; B29K 105/16; B33Y 10/00; B33Y 40/20; B33Y 70/00; C08F 220/18; C08F 220/28; C08F 222/10; C09D 133/06; C09D 133/14; C09D 135/02

(52) U.S. Cl. CPC C09D 4/00; B33Y 70/00; C08F 220/1809; C08F 220/281; C08F 220/282; C08F 222/1061; C09D 133/062; C09D 133/14; C09D 135/02; B29C 64/112; B29C 64/30; B29K 2023/04; B29K 2067/00; B29K 2075/00; B29K 2105/0002; B29K 2105/0088; B29K 2105/0094; B29K 2105/16; B29K 2995/0077; B29K 2995/0089; B33Y 10/00; B33Y 40/20

(57) ABSTRACT

A liquid, radiation curable composition with a viscosity of 4000 cps or lower comprising component a) 20 to 60 weight percent of one or more oligomer(s), pre-polymer(s) or polymer(s) containing a plurality of ester linkages in the backbone, at least one or more urethane groups and at least two ethylenic unsaturated groups which can form polymeric crosslink networks with the other components in the composition in the presence of radicals, anions, nucleophiles or combination thereof, component b) 30 to 90 weight percent of one or more monomer(s) containing one ethylenic unsaturated group capable of forming polymeric crosslink networks with the other components in the composition in presence of radicals, anions, nucleophiles or combination thereof, component c) 0.01 to 10 weight percent of one or more photoinitiator(s) capable of producing radicals when irradiated with actinic radiation and component d) 0 to 40 weight percent of one or more additive(s) selected from the group consisting of filler(s), pigment(s), thermal stabilizer(s), UV light stabilizer(s), UV light absorber(s), radical inhibitor(s) or oligomer(s) as processing aid, said oligomers are different from the oligomers in component a).

This invention relates to liquid radiation curable compositions suitable for additive manufacturing processes to obtain three dimensional objects with high toughness.

Additive manufacturing of three-dimensional plastic objects through layer-by-layer solidification of liquid polymeric resinous materials by means of radiation curing process (i.e. UV irradiation) has been well known for several years as vat photopolymerization. In general, the radiation source for the curing process can be in terms of laser writing (also known as Stereolithography or SLA), digital projection image (also known as Digital Light Processing or DLP) and/or mask-stereolithography (mSLA or LCD technology). In these processes, two dimensional cross-sectional slices or patterns are generated by a computer aided design (CAD) software and subsequently the forming of three-dimensional structures is achieved through the in-situ curing (solidification) of liquid resin according to the preformed two-dimensional cross-sectional layer of the intended object. After a continuous repetitive process, a three-dimensional structure, namely green body, will be obtained. Following a series of washing and post-curing (thermal and UV) processes, the green body will be converted into article with final mechanical and thermal properties.

In the past, vat photopolymerization is generally associated with ‘rigid’ and ‘brittle’ parts production. Such brittleness hindered vat photopolymerization materials for broader application, especially towards functional end-use parts. With rapid advances in both material and printing technology, currently, vat photopolymerization technology is geared towards the direct manufacturing of functional end-use parts. One of the major challenges is the limited availability of high-performance materials for vat photopolymerization that have high toughness and high durability as outlined in the review article Polymer Chemistry (2016), 7, 257-286. High toughness is needed to ensure that the hard and rigid 3D printed article is also difficult to break (absorbing more energy before break) and relatively ‘flexible’, similar to the mechanical properties of ABS, polycarbonate or polypropylene. In general, tough resin requires moderate to high mechanical stresses to deform (e.g. ≥30 MPa) and can be flexible or deformed with higher strain before breaking (e.g. elongation at break ≥30% or even ≥50-80%). According to the review article, there are several ways to achieve high toughness, i.e. the use of suitable monomer, the use of additives such as inorganic silica particles and rubber additives, designing phase separation network and the use of chain transfer agent in order to regulate the network.

Based on such strategy, several attempts have been made in the following prior art references to achieve tough photopolymer resin formulations. WO2006107759A2 and U.S. Pat. No. 7,211,368B2 disclose tough and hard resin formulations based on a urethane acrylate oligomer, a reactive solvent, a cross linking agent, an anti-nucleation agent as well as tough resin formulation based on a urethane acrylate oligomer, an acrylate monomer, and a polymerization modifier. These resins, however, are still comparably brittle.

US20180194885A1 discloses the use of combination of at least one (meth)acrylate monomer or oligomer with at least one mono-functional (meth)acrylate monomer comprising a polycyclic moiety having at least three rings that are fused or condensed (e.g. comprises a tricyclodecyl or a dicyclopentadienyl or tricycle-[3,2,1,0]-decane group) in order to improve properties without sacrificing the elongation at break. The toughness of such resins can still be further improved.

U.S. Pat. No. 10,239,255B2 discloses the use of free radical polymerizable liquid comprising of reactive oligomer being the combination of multi-functional methacrylate oligomer and multi-functional acrylate oligomer together with monofunctional monomer.

EP3292157B1 discloses the use of sulfonic acid ester to regulate radical polymerization systems which resulted in regulated polymeric network formed. The addition of these addition fragmentation chain transfer (AFCT), ester-activated vinyl sulfonate ester, enable shortening the polymeric chain without inhibiting polymerization process or compromising speed. This improves toughness but the printed material is still brittle.

Such rapid formation of regulated methacrylate networks yielding tough materials for vat photopolymerization have been demonstrated in Polymer Chemistry (2016) 7, 2009-20 and Angewandte Chemie International edition (2018) 57, 9165. Despite resulting in tough materials, there are some limitations or challenges associated with the approaches presented in the prior art e.g. toxicity of materials or ductility is not satisfactory. Alternative routes towards tough materials continue to be much needed.

It is therefore an object of this invention to provide a liquid radiation curable composition suitable for additive manufacturing applications which provides a sufficient degree of toughness of the additive manufactured article and wherein moderate to high mechanical stress to deform sample can be achieved after curing while still maintaining the flexibility and ability to be deformed with higher strain before breaking.

The object of this invention is achieved by a liquid, radiation curable composition suitable for additive manufacturing processes comprising:
component a) 20 to 60 weight percent of one or more oligomer(s), pre-polymer(s) or polymer(s) containing a plurality of ester linkages in the backbone, at least one urethane group and at least two ethylenic unsaturated groups which can form polymeric crosslink networks with the other components in the composition in the presence of radicals, anions, nucleophiles or combinations thereof.
component b) 30 to 90 weight percent of one or more monomer(s) containing one ethylenic unsaturated group capable of forming polymeric crosslink networks with the other components in the composition in the presence of radicals, anions, nucleophiles or combinations thereof.
component c) 0.01 to 10 weight percent of one or more photoinitiator(s) capable of producing radicals when irradiated with actinic radiation.
component d) 0 to 40 weight percent of one or more additive(s) selected from the group consisting of filler(s), pigment(s), thermal stabilizer(s), UV light stabilizer(s), UV light absorber(s), radical inhibitor(s) or oligomer(s) as processing aid, said oligomers are different from the oligomers in component a),

with the provision that the component b) is different from the monomers forming the oligomer(s)/pre-polymer(s)/polymer(s) of component a) and the composition has a viscosity of no more than 4000 cps at 25° C.

The viscosity is measured using a rotational rheometer equipped with cone plate (2°) at 25° C. and reading is obtained at 1 Hz shear rate.

The sum of components a) to d) equals 100 weight percent.

The viscosity of the liquid, radiation curable composition according to the invention is preferably less than 3000 cps at 25° C. and more preferably less than 2000 cps at 25° C. As mentioned above viscosity is measured using rotational rheometer equipped with cone plate (2°) and reading is obtained at 1 Hz shear rate.

The term “ethylenic unsaturated group” refers to a vinyl, allyl, itaconate or a (meth)acrylate group

The term “(meth)acrylate group” means either a methacrylate group, an acrylate group or a mixture of both.

Component a) of the radiation curable liquid resin composition according to the invention has a plurality of ester linkages in the backbone, at least one or more urethane groups and at least two ethylenic unsaturated group(s).

The ester linkages in the oligomer(s), pre-polymer(s) or polymer(s) of component a) are obtained by reacting aliphatic or aromatic acid(s) or anhydride(s) or mixtures thereof with a mixture of polyol(s) to form polyester polyols.

The mixture of polyols preferably comprises at least one polyol with at least three hydroxyl moieties in a concentration of at least 3 mol % of the reaction mixture of aliphatic or aromatic acid(s) or anhydride(s) and polyols.

The aliphatic or aromatic acid(s) or anhydride(s) are preferably selected from the group consisting of succinic acid, adipic acid, sebacic acid, phthalic acid, terephthalic acid, isophthalic acid, trimellitic acid, pyromellitic acid and their anhydrides or esters and mixtures thereof. Further options include tetrahydrophthalic, hexahydrophthalic acid, hexahydroterephthalic acid, dichlorophthalic acid and tetrachlorophthalic acid, endomethylene tetrahydrophthalic acid, glutaric acid, 1,4 cyclohexanedicarboxylic acid, and—where obtainable—their anhydrides or esters.

The mixture of polyols is preferably selected from the group consisting of ethylene glycol, diethylene glycol, triethylene glycol, tetraethylene glycol, 1,2- and 1,3-propylene glycol, dipropylene glycol, polypropylene, 1,4- and 2,3-butylene glycol, 1,6-hexanediol, neopentyl glycol, trimethylolpropane, tris(βhydroxyethyl)isocyanurate, penta-erythritol, mannitol and sorbitol.

The reaction product yields a polyester-polyol precursor. This polyester-polyol precursor contains a hydroxyl group that is reacted with isocyanate-functionalized (meth)acrylates to form polyester-based urethane (meth)acrylate oligomer, pre-polymer or polymer. In the presence of free radical, the polyester-based urethane (meth)acrylate forms polymeric covalent bonds which results in a network formation. The polyester-based urethane (meth)acrylate oligomer, pre-polymer or polymer is preferably prepared according to the procedures described in EP1323758B1.

The isocyanate-functionalized (meth)acrylates that are reacted with the polyester polyol precurser are the reaction product of a diisocyanate with one hydroxy-functionalized material having at least one ethylenic unsaturated group. The diisocyanate may be aliphatic, (cyclo) aliphatic or cycloaliphatic structure and is preferably selected from the group consisting of ethylene diisocyanate, trimethylene diisocyanate, 1,6-hexamethylene diisocyanate (HMDI), tetramethylene diisocyanate, hexamethylene diisocyanate, 3,3,5-trimethyl-1-isocyanato-3-isocyanato methylcyclohexane (IPDI), 2,2,4-trimethylhexane diisocyanate, 2,4,4,-trimethylhexamethylene diisocyanate (TMDI), norbornane diisocyanate, and mixtures thereof.

The hydroxy-functionalized material having at least one ethylenic unsaturated group is selected from 4-hydroxbutyl acrylate, 2-hydroxyethyl acrylate, 2-hydroxyethyl methacrylate, hydroxypropyl acrylate, hydroxypropyl methacrylate, glycerol monomethacrylate or a mixture thereof.

Alternatively, the isocyanate-functionalized (meth)acrylate can directly be selected from the group consisting of 2-methacryloyloxyethyl isocyanate, 2-acryloyloxyethyl isocyanate, 2-(2-Methacryloyloxyethoxy)ethyl isocyanate and 1,1-(bisacryloyloxymethyl) ethyl isocyanate.

Preferably component a) has a weight average molecular weight of 4000 g/mol-20000 g/mol, more preferably 4000-10000 g/mol.

The weight average molecular weight (Mw) is determined by gel permeation chromatography (GPC) measurement using tetrahydrofuran (THF) as eluent with PS/DVB (polystyrene divinylbenzene) column (size: 4.6 mm I.D.×15 cm, particle size: 3 μm) and PS/DVB (polystyrene divinylbenzene) guard column (size: 4.6 mm I.D.×2 cm, particle size: 4 μm) at a temperature of 40 deg C. and a flow rate of 0.35 mL/min with refractive index detector. The sample concentration is 5 to 6 10 mg/ml in THF with injection amount of 20 μL. The weight average molecular weights are calculated relative to polystyrene standard.

Most preferably component a) is a polyester-based urethane acrylate oligomer prepared according to the procedures described in EP1323758B1 with a weight average molecular weight of 4000-10000 g/mol.

Component b): As described above the radiation curable liquid resin composition according to the invention comprises 30 to 90 weight percent of one or more monomer(s), each monomer containing one ethylenic unsaturated group capable of forming polymeric crosslink networks with the other components in the composition in the presence of radicals, anions, nucleophiles or combinations thereof.

Preferably the radiation curable liquid resin composition according to the invention comprises 40 to 80 weight percent of component b).

Component b) of the radiation curable liquid resin composition according to the invention is preferably a monomer with one (meth)acrylate group. As used herein, the term (meth)acrylate refers to the esters of acrylic or methacrylic acid as well as esters of derivatives of acrylic or methacrylic acid. For reference purpose, herein, the term “monomer” refers to a monofunctional and multifunctional low molecular weight (meth)acrylate structure.

The monomer with at least one (meth)acrylate group in component b) further comprises a hydrocarbon group selected from C2-C30 linear, cyclic, branched, aliphatic, aromatic, alicyclic, cycloaliphatic group.

More preferably the hydrocarbon group carries polar functional groups selected from the group consisting of hydroxy, carboxy, urethane or urea.

It was found that additional polar functional groups have the advantageous effect of (i) viscosity reduction which improves printing processability and (ii) chain interaction enhancement which improves the cured article toughness.

Preferably component b) has weight average molecular weight of 100-600 g/mol, more preferably 100-400 g/mol.

The weight average molecular weights (Mw) is determined by gel permeation chromatography (GPC) measurement using tetrahydrofuran (THF) as eluent with PS/DVB (polystyrene divinylbenzene) column (size: 4.6 mm I.D.×15 cm, particle size: 3 μm) and PS/DVB (polystyrene divinylbenzene) guard column (size: 4.6 mm I.D.×2 cm, particle size: 4 μm) at a temperature of 40 deg C. and a flow rate of 0.35 mL/min with refractive index detector. The sample concentration is 5 to 6 10 mg/ml in THF with injection amount of 20 μL. The weight average molecular weights are calculated relative to polystyrene standard.

Most preferably component b) is selected from 4-hydroxbutyl acrylate, 2-hydroxyethyl acrylate, 2-hydroxyethyl methacrylate, hydroxypropyl acrylate, hydroxypropyl methacrylate, beta-carboxyethyl acrylate, glycerol monomethacrylate or mono-2-(Acryloyloxy)ethyl succinate, tetrahydrofurfuryl acrylate, tetrahydrofurfuryl methacrylate, isobornyl acrylate, isobornyl methacrylate, cyclic trimethylolpropane formal acrylate, cyclic trimethylolpropane formal methacrylate, 3,3,5-trimethylcyclohexyl acrylate, 3,3,5-trimethylcyclohexyl methacrylate, 4-tert-butyl cyclohexyl acrylate, ethoxylated phenyl monoacrylate, ethoxylated phenyl monomethacrylate, 2-ethylhexyl acrylate or 2-(2-ethoxy-ethoxy)ethyl acrylate, 2-[[(Butylamino)carbonyl]oxy]ethyl acrylate, cyclohexyl acrylate, cyclohexyl methacrylate, phenoxyethyl acrylate, phenoxyethyl methacrylate, poly(ethylene glycol) methacrylate and mixtures of thereof.

Component c) in the liquid radiation curable resin composition according to the invention is a photoinitiator, preferably a free radical photoinitiator,

More preferably the free radical photoinitiator is an aromatic ketone type photoinitiator or a phosphine oxide type photoinitiator.

Aromatic ketone type photoinitiators are preferably selected from the group consisting of 1-hydroxycyclohexyl phenyl ketone, 2-hydroxy-1-(4-(4-(2-hydroxy-2-methylpropionyl) benzyl)phenyl-2-methylpropan-1-one, 2-hydroxy-2-methyl-1-phenylpropanone, 2-hydroxy-2-methyl-1-(4-isopropylphenyl)propanone, oligo (2-hydroxy-2-methyl-1-(4-(1-methylvinyl)phenyl)propanone, 2-hydroxy-2-methyl-1-(4-dodecylphenyl)propanone, 2-hydroxy-2-methyl-I-[(2-hydroxyethoxy)phenyl]propanone, benzophenone, substituted benzophenones, 2,2-Dimethoxy-1,2-diphenylethanone or mixtures thereof.

Phosphine type photoinitiators are preferably selected from the group consisting of diphenyl(2,4,6-trimethylbenzoyl) phosphine oxide (TPO), phenylbis(2,4,6-trimethylbenzoyl) phosphine oxide (BAPO) or Ethyl phenyl(2,4,6-trimethylbenzoyl)phosphinate (TPO-L) or mixtures thereof.

The amount of photoinitiator added to the liquid curable formulation ranges from 0.01% to 10% weight of the total liquid formulation. The photoinitiator(s) are capable of producing radicals when irradiated with actinic radiation. Preferably the actinic radiation source irradiating the said photoinitiator is a mercury lamp, a LED source or even a LCD source that has an emission wavelength between 230 nm to 600 nm.

The liquid, radiation curable resin composition according to the invention may comprise of one or more additive(s) selected from the group consisting of filler(s), pigment(s), thermal stabilizer(s), UV light stabilizer(s), UV light absorber(s), radical inhibitor(s) or additional oligomer(s) as processing aid, said oligomers are different from the oligomers in component a).

Filler(s) may be inorganic or organic particles or mixtures of both. Preferably filler(s) are nano-sized to micron-sized inorganic particles selected from the group consisting of silica, alumina, zirconia, titania or mixtures thereof. In case the filler(s) include organic particles, such nano-sized to micron-sized organic particles are selected from the group consisting of poly(methyl methacrylate), poly(vinyl alcohol), poly(vinyl butyrate), polyamide, polyimide or mixtures thereof.

UV light absorbers are preferably selected from the group consisting of 2-isopropylthioxanthone, 1-phenylazo-2-naphtol as well as optical brightener such as 2,5-bis-(5-tert-butyl-2-benzoxazolyl) thiophene, 4,4′-bis(2-methoxystyryl)-1,1′-biphenyl. In some embodiments, light stabilizer is selected from the group consisting of 2,2,6,6-Tetramethyl-4-piperidinol; bis(2,2,6,6,-tetramethyl-4-piperidyl)sebaceate; bis (1,2,2,6,6-pentamethyl-4-piperidyl) sebacate and Methyl 1,2,2,6,6-pentamethyl-4-piperidyl sebacate; decanedioic acid, bis (2,2,6,6-tetramethyl-1-(octyloxy)-4-piperidinyl) ester; bis (1,2,2,6,6-pentamethyl-4-piperidinyl)-[[3,5-bis (1,1-dimethylethyl)-4-hydroxyphenyl]methyl] butylmalonate or mixtures thereof.

A polymerization or radical inhibitor as well as stabilizing agent can be added to provide additional thermal stability. Suitable radical inhibitors are methoxyhydroquinone (MEHQ) or various aryl compounds like butylated hydroxytoluene (BHT).

In another aspect of the invention, the additional oligomer(s) under component d) are different from oligomer(s), polymer(s) or pre-polymer(s) of component a). Such additional oligomers are selected so as to increase cure speed or lower the viscosity of the liquid radiation curable composition which enhances the processability of the liquid, radiation curable composition according to the invention. In addition to this, the additional oligomer(s) may also improve the polymer network formed e.g. by increasing the glass transition temperature (T_{g}) of the formed polymeric crosslink network, increasing heat deflection temperature (HDT) of the additively manufactured three-dimensional object and/or increasing in the impact resistance behavior of the additively manufactured three-dimensional object.

It is further preferred that the liquid radiation curable composition according to the invention has a specific weight ratio of component a) to component b). The weight ratio of oligomer(s)/pre-polymer(s)/polymer(s) of component a) to monomer(s) of component b) ranges from 20:80 to 60:40 (component a)/component b) provided that the viscosity of the liquid radiation curable composition remains below 4000 cps at 25° C.

The resin composition according to the invention is especially suitable to be used in an additive manufacturing process. Such an additive manufacturing process usually comprises the repeated steps of deposition or layering, and irradiating the composition to form a three dimensional object. Irradiation can be provided by a UV or DLP light engine. In a preferred embodiment of the invention, the total actinic irradiation dose required for the curing of the liquid radiation curable composition per layer is greater than 30 mJ/cm² per layer 100 μm layer thickness. The total actinic irradiation dose can be up to 600 mJ/cm² for a 100 μm layer thickness print setting. More preferably if the total actinic irradiation is between 30 mJ/cm² and 120 mJ/cm² at 100 μm layer thickness. For a commercial DLP 3D printer that has light intensity of 10 mW/cm², 30 mJ/cm² per layer is equivalent to 3 seconds of total irradiation process per layer curing. When other layer thickness print setting is used (e.g. 10 μm, 20 μm and 50 μm), the total actinic irradiation dose required for the curing of the liquid radiation curable composition per layer must be scaled accordingly.

The term “DLP” or “digital light processing” refers to an additive manufacturing process in which a three-dimensional object is formed by curing the liquid radiation curable resins using actinic irradiation into solid objects by means of DLP display device based on optical micro-electro-mechanical technology that uses a digital micromirror device.

The additive manufacturing process that uses the liquid radiation curable composition according to the invention may comprise additional process steps like cleaning, washing, sonication, additional dosage of radiation, heating, polishing, coating or combinations thereof.

Unexpectedly, it was found that the liquid, radiation curable resin composition according to the invention attains three-dimensional objects with moderate to high tensile strength and high elongation at break. This results in high tensile toughness (derived from the stress-strain curve that is measured according to ASTM D638 standard tensile testing method).

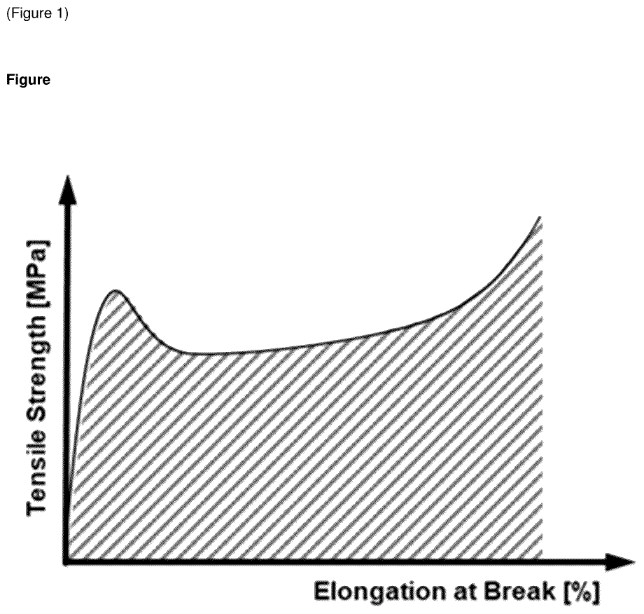

FIG. 1. is a plot of tensile strength vs elongation at break. The hatched area under the curve determines the tensile toughness of the measured specimen. As shown in FIG. 1, tensile toughness refers to the area under the stress-strain curve obtained from tensile tester. Upon completion of the printing and successful post-curing processes, the mechanical properties of the resin composition such as ultimate tensile strength and elongation at break are in the range of 25.0 to 60.0 MPa and 30.0%-165.0% respectively. Such high-performance materials properties are also coupled with superior processability. Such unique combination will result in the ultimate tensile strength and elongation at break that will give rise to tensile toughness >15 J/m³ measured according to the ASTM D638 standard testing method.

Thus, the invention also encompasses a three-dimensional object generated by an additive manufacturing process using the liquid radiation curable composition according to the invention. Such a three-dimensional object printed using the liquid radiation curable composition according to the invention exhibits a tensile toughness of at least 15 J/m³ measured according to ASTM D638.

Overall, the ultimate tensile strength, elongation at break are determined from the stress-strain curve whereas the tensile toughness is determined from the integration of the stress-strain curve. It is noted that the tensile toughness is highly dependent on both tensile strength and tensile deformation. The tensile toughness of the three-dimensional object printed using the liquid radiation curable composition according to the invention can be in the range of 15 J/m³ to 100 J/m³. More preferably between 15 J/m³ to 50 J/m³. Most preferably, between 15 J/m³ to 35 J/m³.

In another aspect of the present invention three-dimensional object generated by an additive manufacturing process using the liquid radiation curable composition according to the invention demonstrates isotropic behavior. The three-dimensional objects can be printed in various orientation such as XY direction, YZ direction, XZ direction, Z direction and other custom direction where an angle is selected against any of the X, Y and Z planes. According to this aspect of the invention, the tensile strength, elongation at break and tensile toughness of the objects in XY direction (parallel to the build platform) and in Z direction (perpendicular to the build platform) as determined by ASTM D638 method should differ not more than 20% from each other.

### EXAMPLES

The subject matter of the present invention is illustrated in more detail in the following examples, without any intention that the subject matter of the present invention be restricted to these examples.

The liquid radiation curable resin composition is prepared by mixing the ingredients as mentioned in the tables below in a mixing equipment. The polyester-based urethane acrylate oligomer used as component a) in the examples below (termed acrylated polyester oligomer in the table) is prepared according to the procedures described in EP1323758B1. This polyester-based urethane acrylate oligomer has a molecular weight of 6300 g/mol, an acrylate functionality greater than 2.5 and a viscosity of approximately 2800 cps at 40° C. and 39000 cps at 25° C.

The viscosity is measured using rotational rheometer equipped with cone plate (2°) and reading is obtained at 1 Hz shear rate. Unless otherwise indicated viscosity is measured at a temperature of 25° C.

The thus prepared resin composition is used to generate the tensile specimens through DLP 3D printing process with an actinic irradiation between 30 and 140 mJ/cm².per 100 micron layer thickness.

The tensile toughness was determined from the area under the stress-strain curve of the specimen measured according to ASTM D638 (see FIG. 1).

Table 1 summarizes the abbreviations used for the monomers.

Tables 2 and 3 summarize the resin compositions and properties of the 3D printed specimen.

TABLE 1
Abbreviation of the monomers

| Abbreviation | Description |
|---|---|
| IBoA | Isobornyl acrylate |
| 2-HEA | 2-Hydroxyethyl acrylate |
| 2-HEMA | 2-Hydroxyethyl methacrylate |
| 2-BACOEA | 2-[[(Butylamino)carbonyl]oxy]ethyl acrylate |
| TMCHA | 3,3,5-trimethyl cyclohexyl acrylate |
| CTFA | Cyclic trimethylolpropane formal acrylate |
| A-LEN-10 | Ethoxylated o-phenylphenol acrylate |
| GLYFOMA | Glycerol formal acrylate |
| BAPO | Phenylbis(2,4,6-trimethylbenzoyl)phosphine oxide |
| TCDDA | Tricyclodecane Dimethanol Diacrylate |
| TPGDA | Tripropylene Glycol Diacrylate |

### Example 1

Compositions 1A, 1B, 1C, 1D and 1E are comparative examples with component a) falling below or exceeding the weight % of the composition range according to the invention. Compositions 1F and 1G comprise component a) in the range according to the invention but composition b) is a mixture of two monomers one monomer having one ethylenic unsaturated group and one monomer having two ethylenic unsaturated groups.

TABLE 2
Compositions for liquid radiation curable resin for 3D printing

| Composition | | 1A | 1B | 1C | 1D | 1E | 1F | 1G |
|---|---|---|---|---|---|---|---|---|
| Component a) | Acrylated | 8.3% | 8.3% | 8.3% | 66.6% | 66.6% | 50.0% | 50.0% |
| | Polyester | | | | | | | |
| | Oligomer | | | | | | | |
| Component b) | IBoA | 2.8% | 2.8% | 2.8% | 22.2% | 22.2% | 16.7% | 16.7% |
| Component b) | TMCHA | 88.9% | | | 11.1% | | | |
| Component b) | 2-HEMA | | 88.9% | | | 11.1% | | |
| Component b) | CTFA | | | 88.9% | | | | |
| Component b) | TCDDA | | | | | | 33.3% | |
| Component b) | TPGDA | | | | | | | 33.3% |
| Component b) | 2-HEA | | | | | | | |
| Component b) | 2-BACOEA | | | | | | | |
| Component b) | A-LEN-10 | | | | | | | |
| Component b) | GLYFOMA | | | | | | | |
| Component c) | Photoinitiator | 1.0 | 1.0 | 1.0 | 1.0 | 1.0 | 1.0 | 1.0 |
| | [BAPO] | PHR | PHR | PHR | PHR | PHR | PHR | PHR |

| | | | | | | | |
|---|---|---|---|---|---|---|---|
| Viscosity [cps] | 7 | 17 | 46 | 47400 | 21600 | 18000 | 3820 |

| | | | | | | |
|---|---|---|---|---|---|---|
| Tensile Toughness [J/m³] | 0.52 | 0.42 | 6.91 | Not Printable | 6.8 | 9.1 |

Example 1A, 1B, 1C demonstrated low viscosity resin <50 cps and printability, however, the tensile toughness of these samples was below 15 J/m³.

Example 1D and 1E showed the composition leads to a viscosity of 47400 and 21600 cps, far exceeding the viscosity of 4000 cps at 25° C. Tensile properties of example 1D and 1E could not be measured as composition given in example 1D and 1E was unable to be printed by DLP 3D printer. Going beyond the weight range given for component a) according to the invention affects either the tensile toughness or viscosity of the composition significantly.

Example 1F and 1G demonstrate the effect of using monomers for component b) with two ethylenic unsaturated groups instead of just one according to the invention. Even if the formulation also contains component b) with one ethylenic unsaturated group, adding monomers with two ethylenic unsaturated groups leads to a tensile toughness below 15 J/m³.

### Example 2

TABLE 3
Compositions for liquid radiation curable resin for 3D printing

| Composition | | 2F | 2G | 2H | 2I | 2J | 2K |
|---|---|---|---|---|---|---|---|
| Component a) | Acrylated | 50.0% | 50.0% | 50.0% | 50.0% | 50.0% | 50.0% |
| | Polyester | | | | | | |
| | Oligomer | | | | | | |
| Component b) | IBoA | 50.0% | 16.7% | 16.7% | 16.7% | 16.7% | 16.7% |
| Component b) | TMCHA | | | 33.3% | | | |
| Component b) | 2-HEMA | | | | | | |
| Component b) | CTFA | | | | | | |
| Component b) | 2-HEA | | 33.3% | | | | |
| Component b) | 2-BACOEA | | | | 33.3% | | |
| Component b) | A-LEN-10 | | | | | 33.3% | |
| Component b) | GLYFOMA | | | | | | 33.3% |
| Component c) | Photoinitiator | 1.0 | 1.0 | 1.0 | 1.0 | 1.0 | 1.0 |
| | [BAPO] | PHR | PHR | PHR | PHR | PHR | PHR |

| | | | | | | |
|---|---|---|---|---|---|---|
| Viscosity [cps] | 3870 | 812 | 2140 | 2680 | 1690 | 1490 |
| Tensile Toughness [J/m³] | 25.9 | 25.3 | 15.9 | 17.89 | 18.41 | 23.5 |

Compositions 2F, 2G, 2H, 2I, 2J and 2K according to the invention all show a tensile toughness exceeding 15 J/m³. The viscosity of these samples is below 4000 cps.

### Example 3

For a three-dimensional object formed by an additive manufacturing process using a liquid radiation curable composition according to invention the tensile strength, elongation at break and tensile toughness in XY direction (parallel to the build platform) and in Z direction (perpendicular to the build platform) as determined by ASTM D638 method should differ not more than 20% from each other.

TABLE 4
Composition for a printed three-dimensional
object demonstrating isotropic behavior

| | |
|---|---|
| Composition | 3L |

| Methacrylated Polyester Oligomer | 50.0% | | |
|---|---|---|---|
| IBoA | 16.7% | | |
| TMCHA | 33.3% | | |
| TPO | 2.0 PHR | | |
| Carbon Black | 0.07 PHR | | |
| Print Direction | XY | Z | Δ |
| Ultimate Tensile Strength [MPa] | 24.0 | 21.3 | −11.25% |
| Elongation at Break [%] | 127.0 | 121.0 | −4.7% |
| Tensile Toughness [J/m³] | 21.1 | 17.3 | −17.9% |

The results shown in Table 4 describe the isotropic behavior of the printed three-dimensional object using a liquid radiation curable composition according to the invention. As can be seen from Table 4, tensile strength, elongation at break and tensile toughness of the printed specimen in XY direction and in Z direction all differ less than 20%.

1-14. (canceled)

15. A liquid radiation curable composition comprising the following components:
a) 20 to 60 weight percent of one or more oligomer(s), pre-polymer(s) or polymer(s) containing a plurality of ester linkages in the backbone, at least one urethane group and at least two ethylenic unsaturated groups that can form polymeric crosslink networks with the other components in the composition in the presence of radicals, anions, nucleophiles or combinations thereof;
b) 30 to 90 weight percent of one or more monomer(s) comprising one ethylenic unsaturated group capable of forming polymeric crosslink networks with the other components in the composition in the presence of radicals, anions, nucleophiles or combinations thereof;
c) 0.01 to 10 weight percent of one or more photoinitiator(s) capable of producing radicals when irradiated with actinic radiation;
d) 0 to 40 weight percent of one or more additive(s) selected from the group consisting of: filler(s); pigment(s), thermal stabilizer(s), UV light stabilizer(s), UV light absorber(s), radical inhibitor(s), and oligomer(s) as a processing aid, wherein said oligomers are different from the oligomers in component a);
with the provision that component b) is different from the monomers forming the oligomer(s)/pre-polymer(s)/polymer(s) of component a) and the composition has a viscosity of no more than 4000 cps at 25° C.

16. The liquid radiation curable composition of claim 15, wherein the viscosity of the composition is less than 3000 cps at 25° C.

17. The liquid radiation curable composition of claim 15, wherein the ester linkages in the oligomer(s), pre-polymer(s) or polymer(s) of component a) are obtained by reacting aliphatic or aromatic acid(s) or anhydride(s) or mixtures thereof with a mixture of polyol(s) to form polyester polyols.

18. The liquid radiation curable composition of claim 17, wherein the mixture of polyols comprises at least one polyol with at least three hydroxyl moieties in a concentration of at least 3 mol % of the reaction mixture of aliphatic or aromatic acid(s) or anhydride(s) and polyols.

19. The liquid radiation curable composition of claim 17, wherein the aliphatic or aromatic acid(s) or anhydride(s) are selected from the group consisting of: succinic acid, adipic acid, sebacic acid, phthalic acid, terephthalic acid, isophthalic acid, trimellitic acid, pyromellitic acid and their anhydrides or esters, and mixtures thereof.

20. The liquid radiation curable composition of claim 17, wherein the mixture of polyols is selected from the group consisting of: ethylene glycol, diethylene glycol, triethylene glycol, tetraethylene glycol, 1,2- and 1,3-propylene glycol, dipropylene glycol, polypropylene, 1,4- and 2,3-butylene glycol, 1,6-hexanediol, neopentyl glycol, trimethylolpropane, tris(β-hydroxyethyl)isocyanurate, penta-erythritol, mannitol and sorbitol.

21. The liquid radiation curable composition of claim 17, wherein component a) is obtained by reacting the polyester-polyols with isocyanate-functionalized (meth)acrylates to form polyester-based urethane (meth)acrylate.

22. The liquid radiation curable composition of claim 15, wherein the at least one ethylenic unsaturated group of the monomer in component b) is a (meth)acrylate functional group and the monomer in component b) further comprises a hydrocarbon group selected from a C2-C30 linear, cyclic, branched, aliphatic, aromatic, alicyclic or cycloaliphatic group.

23. The liquid radiation curable composition of claim 22, wherein the one or more monomer(s) in component b) comprise a hydrocarbon group that carries polar functional groups selected from the group consisting of; hydroxy, carboxy, urethane and urea.

24. The liquid radiation curable composition of claim 15, wherein the weight ratio of component a) to component b) ranges from 20:80 to 60:40.

25. The liquid radiation curable composition of claim 18, wherein the aliphatic or aromatic acid(s) or anhydride(s) are selected from the group consisting of: succinic acid, adipic acid, sebacic acid, phthalic acid, terephthalic acid, isophthalic acid, trimellitic acid, pyromellitic acid and their anhydrides or esters, and mixtures thereof.

26. The liquid radiation curable composition of claim 18, wherein the mixture of polyols is selected from the group consisting of: ethylene glycol, diethylene glycol, triethylene glycol, tetraethylene glycol, 1,2- and 1,3-propylene glycol, dipropylene glycol, polypropylene, 1,4- and 2,3-butylene glycol, 1,6-hexanediol, neopentyl glycol, trimethylolpropane, tris(β-hydroxyethyl)isocyanurate, penta-erythritol, mannitol and sorbitol.

27. The liquid radiation curable composition of claim 26, wherein component a) is obtained by reacting the polyester-polyols with isocyanate-functionalized (meth)acrylates to form polyester-based urethane (meth)acrylate.

28. The liquid radiation curable composition of claim 27, wherein the at least one ethylenic unsaturated group of the monomer in component b) is a (meth)acrylate functional group and the monomer in component b) further comprises a hydrocarbon group selected from a C2-C30 linear, cyclic, branched, aliphatic, aromatic, alicyclic or cycloaliphatic group.

29. The liquid radiation curable composition of claim 28, wherein the one or more monomer(s) in component b) comprise a hydrocarbon group that carries polar functional groups selected from the group consisting of; hydroxy, carboxy, urethane and urea.

30. The liquid radiation curable composition of claim 29, wherein the weight ratio of component a) to component b) ranges from 20:80 to 60:40.

31. An additive manufacturing process comprising the repeated steps of deposition or layering, and irradiating the composition of claim 15 to form a three dimensional object.

32. The additive manufacturing process of claim 31, further comprising the steps of cleaning, washing, sonication, additional dosage of radiation, heating, polishing, coating or combinations thereof.

33. A three-dimensional object formed by an additive manufacturing process of claim 31, wherein the three-dimensional object has a tensile toughness of at least 15 J/m³ measured according to ASTM D638.

34. The three-dimensional object of claim 33, wherein the tensile strength and elongation at break of the three-dimensional object measured according to ASTM D638 in XY direction and in Z direction differs by not more than 20% from each other.
